(19) United States
(12) Patent Application Publication
(10) Pub. No.: US 2022/0077628 A1
(43) Pub. Date: Mar. 10, 2022

(54) PLUG SCREW CONNECTION SYSTEM

(71) Applicant: Pflitsch GmbH & Co. KG, Hueckeswagen Nordrhein Westfalen (DE)

(72) Inventors: Andre ROEWEKAEMPER, Lindlar (DE); Martin LECHNER, Lindlar (DE)

(73) Assignee: Pflitsch GmbH & Co. KG, Hueckeswagen Nordrhein Westfalen (DE)

(21) Appl. No.: 17/492,017

(22) Filed: Oct. 1, 2021

Related U.S. Application Data
(63) Continuation of application No. PCT/EP2020/053826, filed on Feb. 14, 2020.

(30) Foreign Application Priority Data
Apr. 1, 2019 (DE) 10 2019 108 455.5

(51) Int. Cl. H01R 13/622; H01R 13/512; H01R 13/436; H01R 13/52; H01R 13/59; H01R 24/86

(52) U.S. Cl. CPC H01R 13/622; H01R 13/512; H01R 13/4367; H01R 24/86; H01R 13/5221; H01R 13/59; H01R 13/5202

(57) ABSTRACT

A plug screw connection system includes a first plug-in connection part and a second plug-in connection part. The first plug-in connection part has a nipple and the second plug-in connection part has a pressure screw. The pressure screw is screwable onto the nipple. The first plug-in connection part and/or the second plug-in connection part has an outer contact receptacle and an inner contact receptacle, which has at least one wire-receiving opening extending completely in the longitudinal direction of the inner contact receptacle from a first cover surface to a second cover surface.

### CROSS-REFERENCE TO RELATED APPLICATIONS

This application is a continuation application of International Application No. PCT/EP2020/053826, filed on Feb. 14, 2020, which claims priority to and the benefit of DE 10 2019 108 455.5, filed on Apr. 1, 2019. The disclosures of the above applications are incorporated herein by reference.

### FIELD

The present disclosure relates to a plug screw connection system, a first plug-in connection part, a second plug-in connection part, an inner contact receptacle and a use of a plug screw connection system.

### BACKGROUND

The statements in this section merely provide background information related to the present disclosure and may not constitute prior art.

Plug-in systems are known from the prior art. Among other things, a plug-in system is known in which an existing plug-in system is arranged inside a screw connection housing specially constructed for this application. On the one hand, the screw connection housing is screwed tightly and sealed to a fastening element on the connection side, and on the other hand, it is sealed and held in place on the cable side with a conventional sealing and retaining system, for example a sealing insert and a pressure screw of a cable screw connection or a complete cable screw connection.

In the case of configurable plug-in systems known from the prior art, a unit consists of individual contact carriers which are inserted into a plug housing after the cable ends have been configured and equipped with the contacts, and in which a corresponding sealing system is arranged on the cable side outside the contact carriers.

The disadvantages of prior art plug-in systems are that they are cost-intensive and have particular disadvantages in the areas of cable protection, strain relief, sealing, insulation and EMC resistance.

### SUMMARY

This section provides a general summary of the disclosure and is not a comprehensive disclosure of its full scope or all of its features.

It is therefore the object of the invention to provide a plug screw connection system that overcomes the disadvantages of the prior art.

The object is solved according to the invention by means of a plug screw connection system including a first plug-in connection part and a second plug-in connection part, wherein the first plug-in connection part has a nipple and the second plug-in connection part has a pressure screw, wherein the pressure screw is screwable onto the nipple, wherein the first plug-in connection part and/or the second plug-in connection part has an outer contact receptacle and an inner contact receptacle, which has at least one wire-receiving opening extending completely in the longitudinal direction of the inner contact receptacle from a first cover surface to a second cover surface.

Furthermore, the object is solved according to the invention by means of a first plug-in connection part for the plug screw connection system, wherein the plug-in connection part includes a nipple with an outer thread and a connection thread, wherein the outer thread is screwable to at least one pressure screw of a second plug-in connection part.

Furthermore, the object is solved according to the invention by means of a second plug-in connection part for the plug screw connection system comprising a pressure screw.

Furthermore, the object is solved according to the invention by means of an inner contact receptacle for the plug screw connection system, wherein the inner contact receptacle comprises a wire-receiving opening extending completely from a first cover surface to a second cover surface in the longitudinal direction of the inner contact receptacle.

Furthermore, the object is solved according to the invention by means of a use of the plug screw connection system for the plug-in connection of a cable with a connection geometry.

Furthermore, the object is solved according to the invention by means of a use of the plug screw connection system for the flying connection of two cables.

In particular, the proposed plug screw connection system has the following advantages. In one embodiment, the plug screw connection system provides secure edge protection when entering housings and control cabinets. The plug screw connection system is characterized in one embodiment by high strain relief. The cables are held securely preferably in accordance with the EN 62444 standard. In one embodiment, the plug screw connection system operates with a large-area seal, and in one embodiment fulfills protection classes up to IP 68 and is dustproof and pressurized waterproof in one embodiment. According to a preferred embodiment, it is provided that the plug screw connection system fulfills protection class IP 69 and is preferably steam jet-proof. In one embodiment, the plug screw connection system has sealing inserts, in particular sealing inserts, for example in metal screw connections, provide full insulation of the cable against a screw connection body. In particular for international use, the plug screw connection system in one embodiment has VDE, UL, CSA and/or EAC certifications. Furthermore, in one embodiment the European EMC and/or ATEX standards are fulfilled.

In one form, a plug screw connection system is provided, which includes a first plug-in connection part and a second plug-in connection part, wherein the first plug-in connection part has a nipple and the second plug-in connection part has a pressure screw, wherein the pressure screw can be screwed onto the nipple, wherein the first plug-in connection part and/or the second plug-in connection part has an outer contact receptacle and an inner contact receptacle, which has at least one wire-receiving opening extending completely in the longitudinal direction of the inner contact receptacle from a first cover surface to a second cover surface.

Further variations of this plug screw connection system, which may be employed individually or in any combination, include: the first plug-in connection part includes a socket and the second plug-in connection part includes a plug; the second plug-in connection part includes a socket and the first plug-in connection part includes a plug; the first plug-in connection part or the second plug-in connection part incudes at least one first contact carrier with at least one contact pin; the first or the second plug-in connection part includes at least one second contact carrier having a contact socket; the nipple has a connection thread for screwing with a connection geometry; the nipple has an external thread for screwing to the pressure screw.

According to the invention, it is provided that the first plug-in connection part, in particular the first contact carrier, has a first outer contact receptacle and a first inner contact receptacle.

In the sense of the invention, the terms “outer contact receptacle” and “outer contact carrier” are used synonymously. In addition, in the sense of the invention, the terms “inner contact receptacle” and “inner contact carrier” are used synonymously.

In one embodiment, it is provided that the second plug-in connection part, in particular the second contact carrier, has a second inner contact receptacle and a second outer contact receptacle.

In one embodiment, it is provided that the second plug-in connection part has a pressure sleeve which is connected to the second inner contact receptacle in a loss-proof manner, in particular can be screwed together.

In one embodiment, it is provided that the second plug-in connection part comprises a pressure element.

In one embodiment, it is provided that the pressure element and the pressure sleeve are one-piece connected to one another.

In one embodiment, it is provided that the pressure element and the pressure sleeve are designed in two parts.

In one embodiment, it is provided that the pressure screw has a sealing ring with which it can be pressed against a connection geometry in a sealing manner.

In another form, a first plug-in connection part for the plug screw connection system is provided, which includes a nipple with an outer thread and a connection thread, wherein the outer thread is screwable to at least the pressure screw of a second plug-in connection part.

In one embodiment, it is provided that the first plug-in connection part is designed as a plug or socket.

A second plug-in connection part for the plug screw connection system including a pressure screw is proposed. Preferably, the second plug-in connection part is configured for connection to the first plug-in connection part. Further preferably, the first plug-in connection part is configured for connection to the second plug-in connection part.

In one embodiment, it is provided that the second plug-in connection part is designed as a plug or socket.

In one embodiment, it is provided that the second plug-in connection part has a pressure sleeve which can be connected, preferably screwed, to the inner contact receptacle or the outer contact receptacle, and has a pressure element by means of which a cable guided in the plug-in connection part is sealable or clampable. In particular, sealing is effected by a pressure exerted by the pressure screw on the pressure element.

In one embodiment, the plug screw connection system proposed above includes a plug.

In one embodiment, the plug includes a nipple.

In one embodiment, the nipple can be configured as a connecting nipple, pipe nipple, double nipple, or further embodiment.

In one embodiment, the nipple is configured as a fastening element of the plug screw connection system to a connection geometry, such as a housing wall, switch cabinet, motor and/or similar components.

The connection geometry is in particular a component through which in particular at least one cable can be guided, and is for example a wall, a housing or a cable guide. In particular, the connection geometry has a receiving recess into which the nipple can be inserted or screwed.

For example, the nipple has a connection thread, in particular for screwing into a thread of the connection geometry or inserting through a bore in the connection geometry and screwing tight with a locknut. In one embodiment, the system can also be welded, soldered, pressed in, glued in, elastically and/or plastically reformed or otherwise positionable and/or fixable in the connection geometry.

In a further embodiment, it is provided that the nipple is configured for a flying connection.

In the sense of the invention, a flying connection means in particular a plug-in connection without fixed installation. For example, a plug-in connection of two cables.

In one embodiment, the nipple has a receiving element for at least one contact carrier with axial positioning and, in particular, radial positioning of the components relative to one another.

In one embodiment, the nipple is configured to receive a cable side member.

In one embodiment, the nipple is configured to receive at least one seal, at least one contour, or the like, wherein in particular the nipple is configured to provide a sealed arrangement of the individual components with respect to each other and with respect to a connection geometry.

In one embodiment, it is provided that the sealing function of the nipple is designed in such a way that in the plugged-in state, or also in the open, i.e. unplugged, state, a seal is achieved in accordance with the respective protection classes with respect to the connection partner or the cable. In particular, longitudinal sealing is achieved.

In the sense of the invention, longitudinal sealing is understood to mean a seal that prevents the passage of gases and/or moisture in the axial direction through a plug-in face, in particular one that is exposed.

In one embodiment, the nipple has contours for retention, for screwing, for labeling, for anti-twist protection, for increased strain relief, and/or other functions.

In one embodiment, the nipple includes elements for contacting a cable shield.

In one embodiment, an O-ring is provided on the nipple.

In one embodiment, it is provided that the plug screw connection system comprises a first contact carrier.

In one embodiment, the first and/or the second contact carrier is formed in one piece or in multiple pieces.

One-piece in the sense of the present invention means that the first contact carrier and/or the second contact carrier each form a unit, so that the respective outer contact receptacle is preferably held in a pre-assembled manner on the respective inner contact receptacle. In one embodiment, however, the inner contact receptacle can be removed and reinserted by the contact carrier in the unassembled state of the same by applying force and, for example, due to the elasticity of the plastic material used to manufacture the outer contact receptacle. In particular, one-piece in the sense of the present invention does not mean that the first contact carrier is inseparably connected to the second contact carrier, although this may also be the case.

In one embodiment, the plug screw connection system includes an O-ring on the first outer contact carrier.

In one embodiment, the plug screw connection system includes a first inner contact carrier.

In one embodiment, a receptacle for the assembled contacts in a system constructed from one or more individual parts, in particular comprising at least the first inner contact carrier and the first outer contact carrier, is provided. If multiple parts are used, one embodiment provides that at least the first contact carrier ensures the positioning and fixing of the individual parts to one another.

In one embodiment, an arrangement of at least one sealant is provided for achieving a seal from dust, water, and/or gases.

In one embodiment, an arrangement of elements is provided for unambiguous positioning relative to the contact partner and the connecting nipple.

In one embodiment, an arrangement of elements is provided for fixation relative to the connecting nipple.

In one embodiment, electrical insulation of the first contact carrier, more preferably the first inner contact carrier and/or the first inner contact carrier with respect to the nipple and/or the individual contacts with respect to each other is provided.

In one embodiment, the plug screw connection system has a socket.

In one embodiment, the plug screw connection system has a second contact carrier.

In one embodiment, the second contact carrier is formed in one piece or in multiple pieces.

In one embodiment, the second contact carrier has a second outer contact carrier and a second inner contact carrier.

In one embodiment, the connector screw system has a second outer contact carrier.

In one embodiment, the connector screw system has a second inner contact carrier with a receptacle, preferably a threaded receptacle.

In one embodiment, it is provided that the second contact carrier has a receptacle of assembled contacts in a plug screw connection system constructed from at least about two individual parts.

If, in the context of the invention, the term “about” is used in connection with values or ranges of values, this is to be understood as a range of tolerance which the person skilled in the art considers to be usual in this field, in particular a range of tolerance of ±20%, preferably ±10%, further preferably ±5% is provided. Insofar as different value ranges, for example preferred and further preferred value ranges, are indicated in the present invention, the lower limits and the upper limits of the different value ranges can be combined with one another.

In one embodiment, the second contact carrier is used to ensure the positioning of the individual parts of the plug screw connection system relative to each other by its individual parts themselves.

In one embodiment it is provided that the contact carrier is configured to ensure the fixation of the contact carrier individual parts by the pressure sleeve.

In one embodiment, an arrangement of at least one sealant is provided for achieving a seal from dust, water, and/or gases.

In one embodiment, an arrangement of elements is provided for unambiguous positioning relative to the contact partner and/or the connection nipple.

In one embodiment, an electrical insulation is provided with respect to the nipple and/or the individual contacts with respect to each other, particularly when the plug and/or the socket contain a conductive material.

In one embodiment, a part of the contact carrier is also provided slotted, multi-part, partially exposed or otherwise designed in an assembly-optimized manner, in particular to ensure assemblability.

In one embodiment, the connector screw connection system has a pressure element or sealing element, preferably with a pressure sleeve. Pressure element and sealing element are used synonymously in the sense of the invention.

In one embodiment, the pressure element and the pressure sleeve are made in one piece.

In the sense of the invention, one-piece means that two parts, for example the pressure sleeve and the pressure element, are materially joined and in particular are made of one material.

In a further embodiment it is provided that the pressure sleeve and the inner contact carrier are made in one piece. In one embodiment, the pressure sleeve is connected to the inner contact carrier, preferably screwed onto inner contact carriers.

In one embodiment, the pressure element and the pressure sleeve are made in two pieces.

In one embodiment, the pressure sleeve is screwed onto outer contact carriers.

In one embodiment, the sealing element is provided for sealing between a cable and a pressure screw.

In one embodiment, the pressure element or sealing element is provided for pressing with the cable. In particular, the pressure element or sealing element is force-locked connected to the cable and/or the pressure screw. Advantageously, the cable is thus fixed as in a cable gland and further preferably relieved of strain.

In one embodiment of the plug screw connection system, the pressure sleeve in particular can be designed as a purity system, which is particularly suitable for the food industry. Further preferably, transitions in the pressed state are selected in the plug screw connection system, in particular on the pressure sleeve, in such a way that there are hardly any or no nesting sites for bacteria. Furthermore, the choice of material for the connector system, in particular for the pressure sleeve, is made in such a way that it is suitable for the food industry.

In one embodiment, it is provided that the pressure element, further preferably all seals of the plug screw connection system, can have or has a soft squeeze and in particular seals over a large area.

In one embodiment, the pressure sleeve has grooves which in particular prevent the sealing insert from turning when the pressure screw is tightened and thus prevent the cable from twisting. In one embodiment, which in particular comprises a metal screw connection, a groove-guided O-ring, in particular made of rubber, ensures a secure seal around the receiving recess of the connection geometry.

In a further embodiment, it is provided that the sealing element, and preferably all seals of the plug screw connection system, seal at least by means of a point squeeze. In particular, at least the sealing element is designed as a multi-part lamellar sealing system. In a further embodiment, it is provided that the pressure element or sealing element, in particular all seals of the plug screw connection system, have any sealing system.

In one embodiment, it is provided that the pressure sleeve has at least one recess. In particular, improved assembly is achieved by the at least one recess.

Advantageously, the pressure sleeve serves to secure the individual contact carrier parts during assembly and disassembly. This advantageously enables simplified handling.

In one embodiment, the pressure sleeve may be integral with a portion of the contact carrier.

In one embodiment, the pressure sleeve can receive at least one pressure element, in particular a standard pressure element.

In one embodiment, the pressure sleeve directs the forces to the first or second contact carrier and/or the nipple during compression of the compression element.

In one embodiment, it is provided that a position of the pressure sleeve in the plug screw connection system can be varied. In particular, a compression of the pressure element, in particular a pressure exerted on the pressure element, can be varied. In particular, a variation of the position and/or the pressure can be generated by means of an adjustment thread, at least one washer or the like.

In one embodiment, the pressure sleeve may be pressed to the second contact carrier. In particular, the pressure sleeve can be screwed to the second contact carrier and/or connected in a loss-proof manner.

In one embodiment, the pressure sleeve has elements for process-safe screwing and/or disassembly.

In one embodiment, the plug screw connection system, in particular the pressure sleeve, has elements for contacting a cable shield. In particular, the plug screw connection system, especially the pressure sleeve, has a closed, triangularly wound wire spiral or spiral spring, preferably to ensure electromagnetic compatibility.

In one embodiment, it is provided that the pressure sleeve comprises elements for an anti-twist protection of the pressure element with respect to the pressure sleeve and/or an anti-twist protection of the pressure sleeve with respect to the connecting nipple.

In one embodiment, the plug screw connection system has a pressure screw.

In particular, the nipple is designed for pressing the arranged individual elements, especially the pressure screw via a thread, bayonet, hook, clips, screws or other detachable fastening elements.

In one embodiment, it is provided that the plug screw connection system has a sealing ring for the pressure screw.

In one embodiment, the plug screw connection system, in particular the pressure screw, is designed as a purity system that is particularly suitable for the food industry. In a further preferred embodiment, transitions in the pressed state are selected in the plug screw connection system, in particular on the pressure screw, in such a way that there are hardly any or no niches or nesting sites for bacteria. Furthermore, a material selection of the plug screw connection system, in particular of the pressure screw, is chosen in such a way that it is suitable for the food industry. In one embodiment, the pressure screw is provided with at least one seal with respect to the nipple or the connection geometry. In one embodiment, it is provided that the pressure screw receives the pressure element. In one embodiment, it is provided that a seal to the pressure element is made by means of the pressure screw.

In one embodiment, it is provided that forces, in particular all forces that occur in particular due to the pressing and/or when the cable is loaded, are absorbed by the pressure screw.

In one embodiment, at least one structural element is provided for assembling or disassembling the plug screw connection system. In particular, the pressure screw has wrench flats, in particular about two, about four or about six wrench flats and/or at least one knurl.

In one embodiment, the individual elements arranged, in particular the pressure screw, are pressed together by means of a thread, bayonet, hook, clips, screws or other detachable fastening elements.

In one embodiment, it is provided that the pressure sleeve has a guide function for the pressure element. In particular, the pressure sleeve can provide a guide function for the pressure screw and/or the contact carrier.

In one embodiment, it is provided that at least one, preferably both sides of the plug screw connection system have a sealed and strain-relieved cable outlet.

When arranging the plug screw connection system as a flying disconnect or flying connection of a cable, the plug screw connection system can be designed as part or as a connecting element of a plug system. A flying connection or flying disconnect is understood in the sense of the invention to mean in particular that the connection is made without connection geometry, in particular a flying connection is a connection of two cables or cable ends.

The advantage of the proposed plug screw connection system is in particular the elimination of a separate plug housing; the pressure screw is screwed directly to the connection nipple.

The advantage of the proposed plug-in screw connection system is in particular that the electrical plug-in connection is achieved by means of individually assembled contacts arranged in easily assembled, single- or multi-part contact carriers.

The advantage of the proposed plug screw connection system is in particular that the contact carriers are inserted in the connection nipple via simple positioning and fixing means or are plugged in during assembly. Advantage of the proposed plug screw connection system is in particular a very compact design. The advantage of the proposed plug screw connection system is in particular that it is constructed with few individual parts. The advantage of the proposed plug screw connection system is in particular that it can be designed as a purity design, especially for the food industry. The advantage of the proposed plug screw connection system is in particular that when the pressure screw is fastened via a standard thread, a desired screw connection path can be defined by a stop. The advantage of the proposed plug screw connection system is, in particular, that the pressure sleeve connected to the second contact carrier makes the plug screw connection system easy to handle as a pre-assembled plug unit and to assemble in a process-safe manner.

In one embodiment, it is provided that the socket has the nipple and the plug has the pressure screw. In particular, the components are interchanged accordingly.

The plug screw connection system, in particular the nipple, the first contact carrier, the second contact carrier, the pressure screw and/or the pressure sleeve comprise in particular at least one material selected from a group comprising a plastic and/or a metal, preferably stainless steel and/or brass.

In one embodiment, it is provided that the pressure element and/or other seals of the plug screw connection system comprise in particular at least one material selected from a group comprising TPE, TPE-V, rubber and silicone.

The nipple and/or the pressure screw have a sealing seat surface. Preferably, a recess for receiving the cable on a receptacle side, the head side and/or a plug-in side is surrounded by a sealing seat surface. Further preferably, a part of a flat surface portion of the receiving side and/or the plug-in side comprises the sealing seat surface. Further preferably, an externally threaded projection of the nipple is surrounded by a sealing seat surface. Advantageously, the sealing seat surface provides at least partial abutment for a seal, in particular a sealing ring. Preferably, the sealing seat surface comprises a metallic or electrically conductive surface. In a further embodiment, a sealing ring surrounding the sealing seat surface is associated with a sealing seat surface. In one embodiment, the sealing ring is provided to be arranged in a recess or groove arranged around the sealing seat surface. In particular, the sealing ring is seated on a step of the recess or a groove base. The groove for receiving the sealing ring is a preferably circular, preferably angular depression in the material of the guide body, in particular the receiving side, the head side and/or the plug-in side, further preferably only the receiving side, the pressure screw and/or the nipple. The recess is preferably directly associated with an edge of a body, in particular the receiving side and/or the plug-in side, the pressure screw and/or the nipple. Further preferably, the recess is circularly circumferential. Further preferably, the recess is an angular depression in the material of the guide body, in particular the receiving side and/or the plug-in side, the pressure screw and/or the nipple. Further preferably, the sealing ring projects beyond the sealing seat surface, in particular by a defined amount. When the pressure screw and/or the nipple are tightened or pressed against the connection geometry, the sealing ring is preferably compressed in a defined manner until the sealing seat surface rests on a surface of the connection geometry or the guide body. As a result, the sealing seat surface and the sealing ring are arranged in one level and form a continuous sealing surface. Preferably, this results in a defined compression of the sealing ring. The recess, in which a sealing ring is inserted, comprises an undercut, in particular for securing the sealing ring, in which the sealing ring engages. The aforementioned embodiments of the seals are preferably provided on all seals of the plug screw connection system, in particular on the seal of the pressure screw and the nipple. The advantageous embodiments described above create, for example, an electrically conductive and/or thermally conductive connection between the pressure screw, nipple and/or connection geometry. Preferably, the plug screw connection system is dust-tight and water-tight according to protection class IP 68, further preferred at about 5 bar to about 10 bar, further preferred IP 69. In particular, the plug screw connection system provides protection during high-pressure cleaning.

Within the scope of the invention, the term “receiving side” refers to the side of the plug and the socket that receives the cable or into which the cable can terminate. Within the scope of the invention, the plug-in side is understood to mean the side of the plug and the socket, respectively, which are opposite each other with the complementary part. In particular, the plug-in side is the side of the plug or socket that is plugged in with the socket or plug, respectively.

Furthermore, an inner contact receptacle for the plug screw connection system is proposed, wherein the inner contact receptacle comprises a wire-receiving opening extending completely from a first cover surface to a second cover surface in the longitudinal direction of the inner contact receptacle.

In one embodiment, a channel is provided between an outer surface of the inner contact receptacle and the wire-receiving opening.

Preferably, in one embodiment, the channel is provided to extend along the full length of the inner contact receptacle. In one embodiment, it is provided that a minimum width of the channel is smaller than or approximately equal to a radius of the wire-receiving opening. In one embodiment, it is provided that the channel becomes narrower or reduces its diameter in the direction of the wire-receiving opening.

A use of a plug screw connection system described above is proposed for the plug connection of a cable with a connection geometry.

A use of a plug screw connection system described above is proposed for the flying connection of two cables.

Further areas of applicability will become apparent from the description provided herein. It should be understood that the description and specific examples are intended for purposes of illustration only and are not intended to limit the scope of the present disclosure.

### DRAWINGS

In order that the disclosure may be well understood, there will now be described various forms thereof, given by way of example, reference being made to the accompanying drawings, in which:

FIG. 1 is an exploded view of a plug screw connection system according to a first embodiment of the present disclosure;

FIG. 2 is a top view of a receiving side of the plug of FIG. 1;

FIG. 3 is a side view of the plug screw connection system of FIG. 1;

FIG. 4 is a cross-sectional view of the plug screw connection system taken along line A-A of FIG. 3;

FIG. 5 is a perspective view of the plugged plug screw connection system of FIG. 1;

FIG. 6 is an exploded view of a plug screw connection system according to a second embodiment of the present disclosure;

FIG. 7 a side view of the plug screw connection system of FIG. 6;

FIG. 8 is a cross-sectional view of the plug connection system taken along line A-A of FIG. 7;

FIG. 9 a perspective view of the plugged plug screw connection system of FIG. 6;

FIG. 10 is a partial exploded side view of a plug screw connection system with separate plug and socket;

FIG. 11 is a cross-sectional view of the plug screw connection system taken along line A-A of FIG. 10;

FIG. 12 is a perspective, partial exploded view of the plug screw connection system of FIG. 10;

FIG. 13 is a perspective view an embodiment of a plug screw connection system;

FIG. 14 is a partial exploded perspective view of the plug screw connection system from FIG. 13 with separate socket and nipple;

FIG. 15 is a cross sectional view of the plug screw connection system from FIG. 13 in a longitudinal section;

FIG. 16 is an embodiment of a plug screw connection system with an angle connector;

FIG. 17 a cross sectional view of is the plug screw connection system from FIG. 16;

FIG. 18 is a partial exploded side view of the plug screw connection system from FIG. 16;

FIG. 19 is a partial exploded cross sectional view of is the plug screw connection system from FIG. 18;

FIG. 20 is a perspective view of an embodiment of a plug screw connection system as a flying connection;

FIG. 21 is a partial exploded side view of the plug screw connection system from FIG. 20;

FIG. 22 is a partial exploded cross sectional view of the plug screw connection system from FIG. 21; and

FIG. 23 is a exploded perspective view of the plug screw connection system from FIG. 20.

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features.

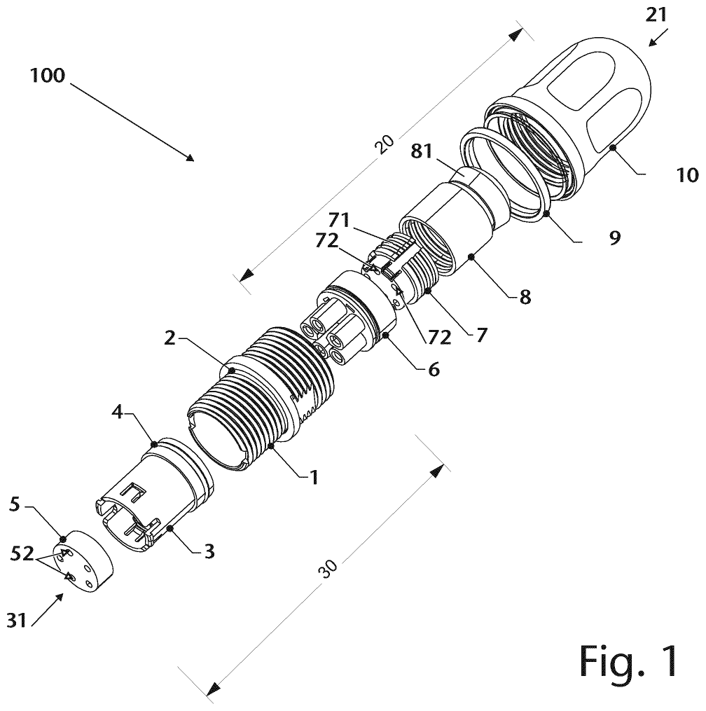

FIG. 1 shows a first embodiment of a plug screw connection system 100 in an exploded view. A socket 20 and a plug 30 can be seen. The plug 30 has a first inner contact carrier 5 and a first outer contact carrier 3. The first outer contact carrier 3 has an O-ring 4. A nipple 1 has an O-ring 2. The first inner contact carrier 5, the first outer contact carrier 3, the nipple 1 and the sealing means, i.e. the O-rings 4 and 2, form a socket into which a cable not shown can be received or assembled from the receiving side 31.

FIG. 1 further shows a socket 20 with a second outer contact carrier 6 and a second inner contact carrier 7. The inner contact carrier 7 with a threaded receptacle 71 can be screwed to a pressure sleeve 8. The pressure sleeve 8 has a pressure element 81 one-piece connected thereto. A pressure screw 10 is designed in such a way that it can be screwed onto the nipple 1 and, in particular, presses the pressure element 81 of the socket in such a way that a cable not shown, which is guided from the receiving side 21 of the socket 20 into the socket or is assembled on it, can be pressed. A sealing ring 9, which interacts with the pressure screw 10, can seal the pressure screw 10 against a connection geometry not shown.

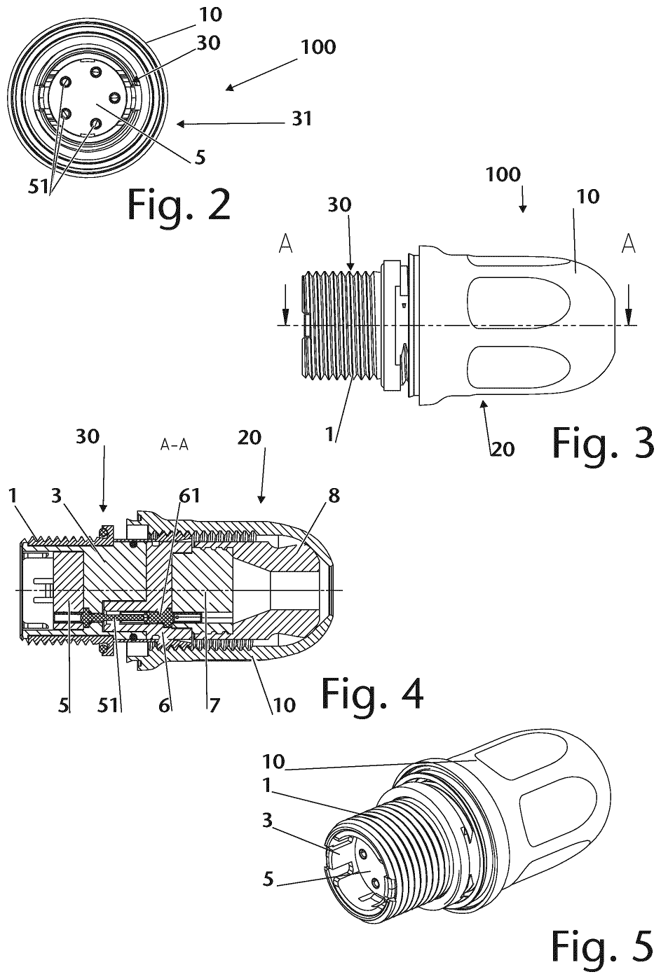

FIG. 2 shows a top view of the receiving side 31 of the plug 30 of the plug screw connection system 100. The pressure screw 10, which at least partially encases the plug 30, can be seen. The inner contact carrier 5 has contact pins 51.

FIG. 3 shows a side view of the plug screw connection system 100 of FIG. 1. The nipple 1 of the plug 30, the pressure screw 10 of the socket 20 can be seen.

FIG. 4 shows a sectional view A-A from FIG. 3. The assembly of the plug 30 with nipple 1, first inner contact carrier 5, first outer contact carrier 3, and a contact pin 51 can be seen. Furthermore, the socket 20 comprises a second outer contact carrier 6, a second inner contact carrier 7, and a contact socket 61. The socket 20 is held on the nipple of the plug 30 by means of the pressure screw 10 and in particular sealed.

FIG. 5 shows a view of the plugged plug screw connection system from FIG. 1. The pressure screw 10, the nipple 1, the first inner contact carrier 5 and the first outer contact carrier 3 can be seen.

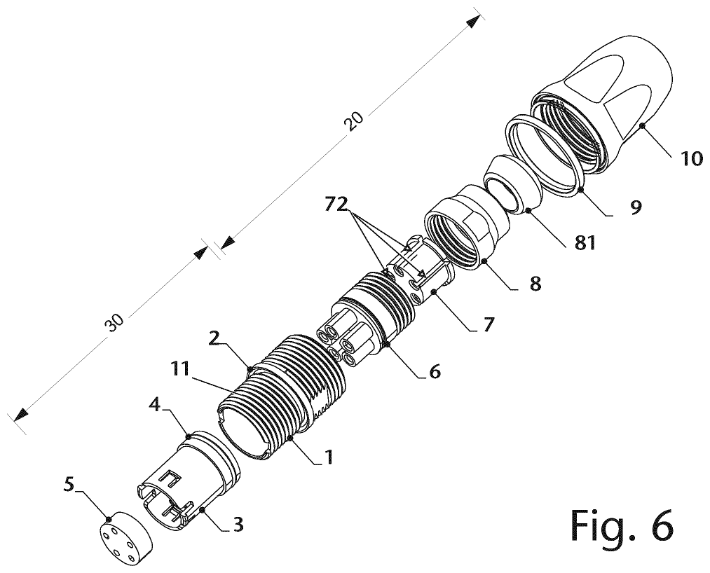

FIG. 6 shows a second embodiment of the plug screw connection system in an exploded view. The socket 20 and the plug 30 can be seen. The plug 30 comprises a first inner contact carrier 5, a first outer contact carrier 3, an O-ring 4 on the first outer contact carrier 3, a nipple 1 with a connection thread 11, with which the nipple 1 can be screwed into a connection geometry not shown, for example. The socket 20 has a second inner contact carrier 7, which includes recesses 72 that facilitate assembly. Furthermore, the socket 20 has a second outer contact carrier 6. The pressure element 81 is formed separately from the pressure sleeve 8. Furthermore, the plug screw connection system 100 comprises a pressure screw 10 with a sealing ring 9.

It is understood that, as described in the general description section, the pressure sleeve 8 one-piece connected to the pressure element 81 can also be combined with the inner contact carrier 7 and have recesses 72.

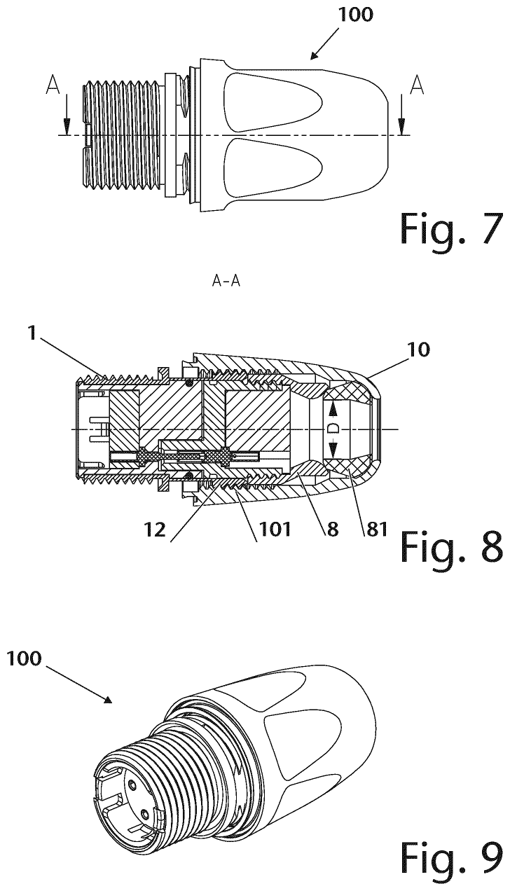

FIG. 7 shows a side view of the plug screw connection system 100 of FIG. 6.

FIG. 8 shows a sectional view A-A of FIG. 7. It can be seen that the pressure screw 10 has an inner thread 101 which interacts with an outer thread 12 of the nipple 1. Furthermore, it can be seen that, by screwing the pressure screw 10 onto the nipple 1, the pressure element 81 is pressed against the pressure sleeve 8, whereby an inner diameter D of the pressure element 81 is reduced and the latter can enter into a non-positive connection with a cable that is not shown.

FIG. 9 shows a view of the plugged plug screw connection system 100 of FIG. 6.

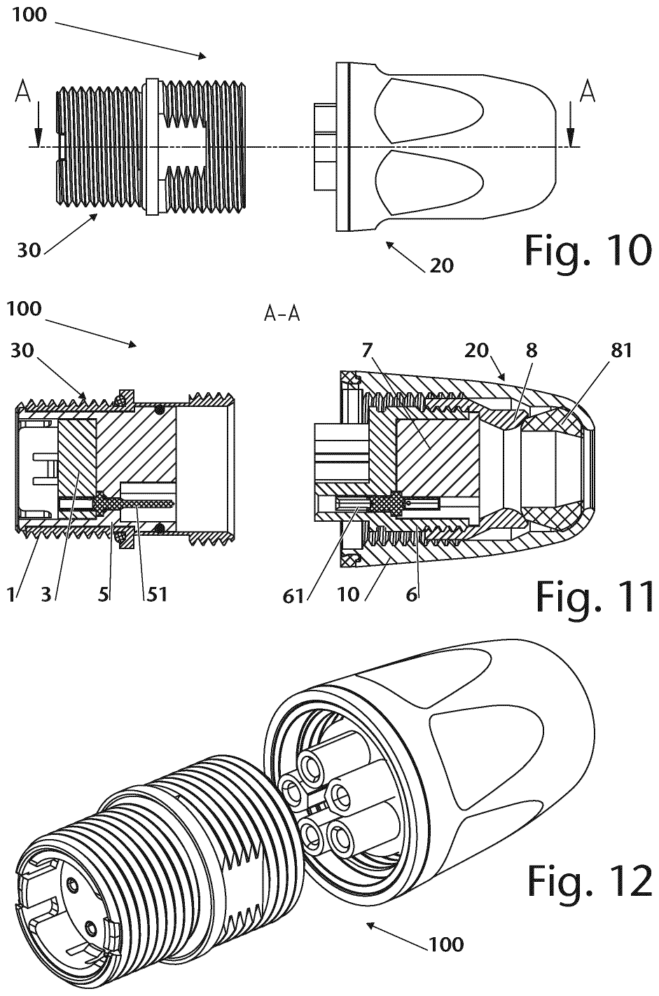

FIG. 10 shows a plug screw connection system with a socket 20 separated from a plug 30.

FIG. 11 shows a sectional view A-A from FIG. 10. The socket 20 with the nipple 1, the first inner contact carrier 5, the first outer contact carrier 3, and the contact pin 51 can be seen. The socket 20 comprises a second outer contact carrier 6, a second inner contact carrier 7, and the contact socket 61. The socket 20 is held on the nipple of the plug 30 by means of the pressure screw 10 and is sealed in particular.

FIG. 12 shows a view of the plug screw connection system 100 of FIG. 10.

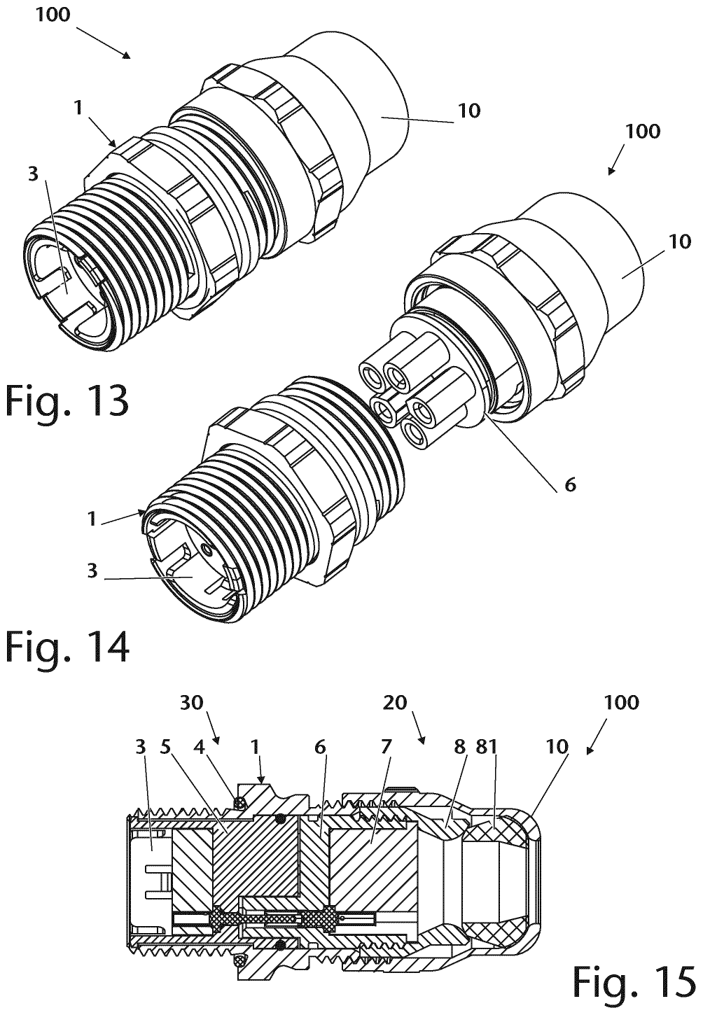

FIG. 13 shows a plug screw connection system 100 with a nipple 1 and a pressure screw 10 in an assembled state. The nipple 1 comprises an outer contact carrier 3.

FIG. 14 shows the plug screw connection system 100 from FIG. 13, in which the outer contact carrier 6 of the socket 20 shown in FIG. 15 is separated from the nipple 1.

FIG. 15 shows the plug screw connection system from FIG. 13 in a longitudinal section. The plug 30 comprises a nipple 1 with an outer contact carrier 3 and an inner contact carrier 5. An O-ring 4 is applied to the nipple 1. The plug 30 is inserted into the socket 20. The socket 20 comprises an outer contact carrier 6 and an inner contact carrier 7. Furthermore, the socket comprises a pressure sleeve 8 and a pressure element 81 resting thereon. The screwed-on pressure screw 10 acts on the pressure element 81.

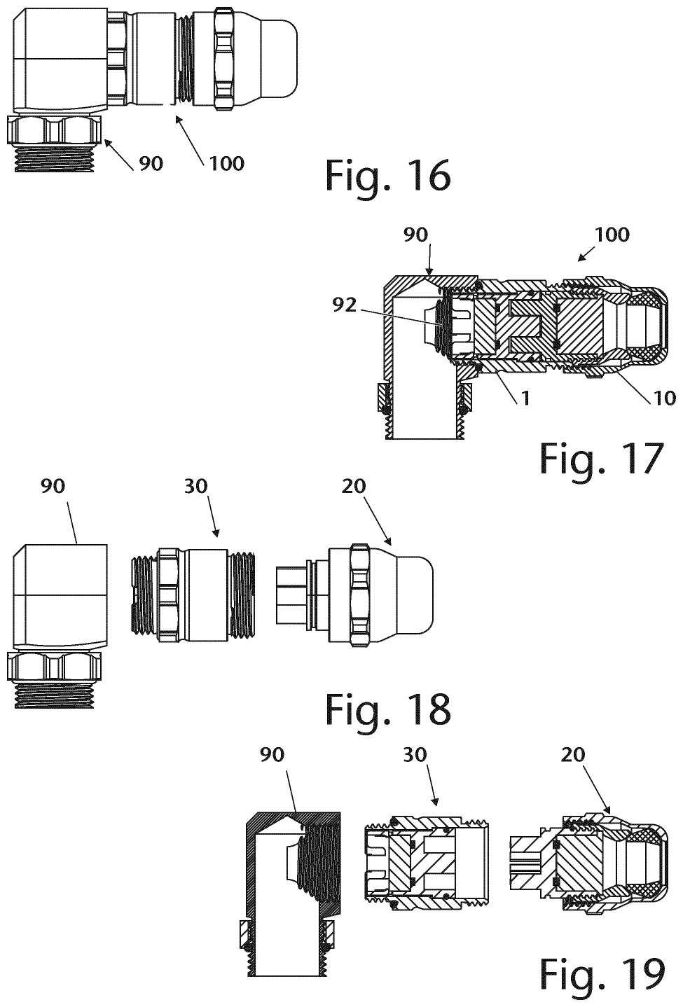

FIG. 16 shows an embodiment of the plug screw connection system 100 with an angle connector 90.

FIG. 17 shows the plug screw connection system 100 in a sectional view. The nipple 1 is screwed into an inner thread 92 of the angle connector 90. Furthermore, the pressure screw 10 is screwed onto the nipple 1.

FIG. 18 shows the plug screw connection system 100 of FIG. 16 comprising the angle connect-or 90, the plug 30 and the socket 20 in an exploded view.

FIG. 19 shows the plug screw connection system 100 of FIG. 18 in a sectional view comprising the angle connector 90, the plug 30 and the socket 20.

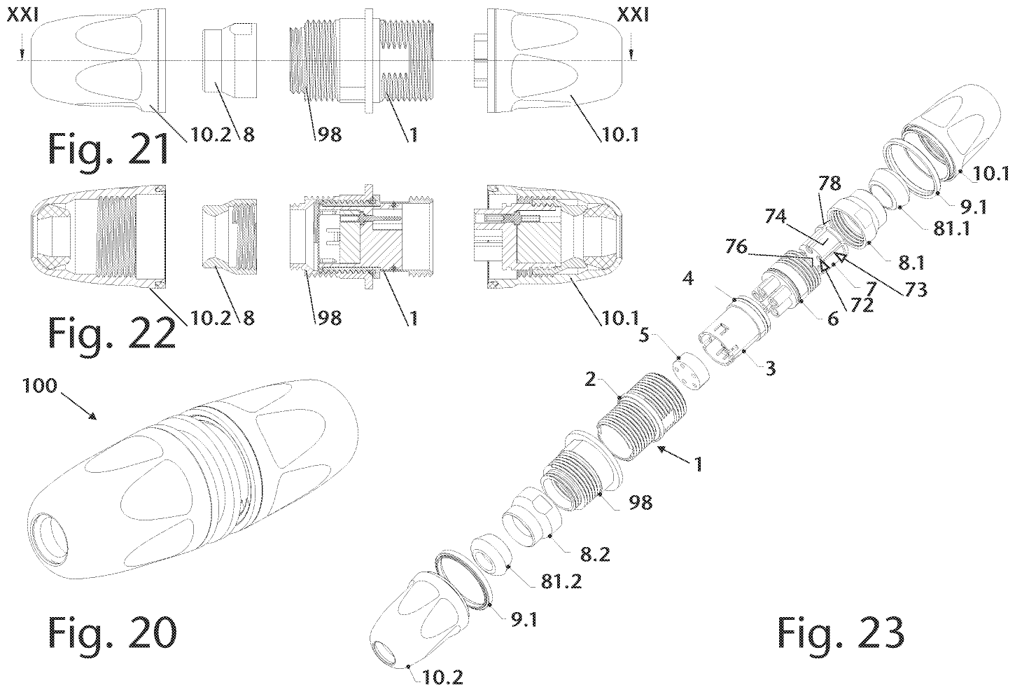

FIG. 20 shows another embodiment of a plug screw connection system 100 as a flying connection.

FIG. 21 shows an exploded view of the plug screw connection system 100 from FIG. 20 comprising a first pressure screw 10.1 and a second pressure screw 10.2. The first pressure screw is screwed onto the nipple 1 on one side. On the opposite side, the second pressure screw 10.2 is screwed onto a connecting piece 98 of the nipple 1.

FIG. 22 shows a sectional view of the plug screw connection system 100 from FIG. 21 comprising a first pressure screw 10.1 and a second pressure screw 10.2. The first pressure screw is screwed onto the nipple 1 on one side. On the opposite side, the second pressure screw 10.2 is screwed onto a connecting piece 98 of the nipple 1.

FIG. 23 shows a detailed exploded view of the plug screw connection system 100 from FIG. 20. The first pressure screw 10.1 is screwed onto the nipple 1. An O-ring 9.1 seals between the pressure screw 10.1 and the connecting piece 98. The first pressure screw 10.1 acts on a first pressure element 81.1, which in turn interacts with a first pressure sleeve 8.1. The pressure sleeve 8.1 engages over an inner contact carrier 7 with wire-receiving openings 72, a channel 73 between an outer surface 74 and a wire-receiving opening 72 and a cover sur-face 76. The inner contact carrier 7 is arranged in the outer contact carrier 6.

The second pressure screw 10.2 can be screwed onto a connecting piece 98, which can be fitted onto the nipple 1. An O-ring 9.1 seals between the second pressure screw 10.2 and the connecting piece 98. The second pressure screw 10.2 acts on a second pressure element 81.2, which in turn interacts with a second pressure sleeve 8.2, which is supported against the connecting element 98. An inner contact carrier 5 and an outer contact carrier 3 are arranged in the nipple 1.

Unless otherwise expressly indicated herein, all numerical values indicating mechanical/thermal properties, compositional percentages, dimensions and/or tolerances, or other characteristics are to be understood as modified by the word “about” or “approximately” in describing the scope of the present disclosure. This modification is desired for various reasons including industrial practice, material, manufacturing, and assembly tolerances, and testing capability.

As used herein, the phrase at least one of A, B, and C should be construed to mean a logical (A OR B OR C), using a non-exclusive logical OR, and should not be construed to mean “at least one of A, at least one of B, and at least one of C.”

The apparatuses and methods described in this application may be partially or fully implemented by a special purpose computer created by configuring a general-purpose computer to execute one or more particular functions embodied in computer programs. The functional blocks, flowchart components, and other elements described above serve as software specifications, which can be translated into the computer programs by the routine work of a skilled technician or programmer.

The description of the disclosure is merely exemplary in nature and, thus, variations that do not depart from the substance of the disclosure are intended to be within the scope of the disclosure. Such variations are not to be regarded as a departure from the spirit and scope of the disclosure.

What is claimed is:

1. A plug screw connection system comprising:
a first plug-in connection part; and
a second plug-in connection part,
wherein the first plug-in connection part has a nipple and the second plug-in connection part has a pressure screw,
wherein the pressure screw is screwable onto the nipple,
wherein the first plug-in connection part and/or the second plug-in connection part has an outer contact receptacle and an inner contact receptacle which has at least one wire receiving opening extending completely in the longitudinal direction of the inner contact receptacle from a first cover surface to a second cover surface.

2. The plug screw connection system according to claim 1, wherein a channel is provided between an outer surface of the inner contact receptacle and the wire receiving opening.

3. The plug screw connection system according to claim 1, wherein the first plug-in connection part and/or the second plug-in connection part has a pressure sleeve which can be connected to the inner contact receptacle or the outer contact receptacle.

4. The plug screw connection system according to claim 1, wherein at least the second plug-in connection part has a pressure element by means of which a cable guided in the plug-in connection part can be sealed or clamped.

5. The plug screw connection system according to claim 4, wherein the pressure element and the pressure sleeve are one-piece connected to one another.

6. The plug screw connection system according to claim 1, wherein the pressure element and the pressure sleeve are designed in two parts.

7. A first plug-in connection part for the plug screw connection system according to claim 1, wherein the plug-in connection part comprises a nipple with an outer thread and a connection thread, wherein the outer thread is screwable to at least one pressure screw of a second plug-in connection part.

8. The first plug-in connection part according to claim 7, further comprising a pressure screw disposed on the connection thread.

9. The first plug-in connection part according to claim 7, wherein the connection thread is screwable to a connection geometry.

10. A second plug-in connection part for a plug screw connection system according to claim 1 comprising a pressure screw.

11. The second plug-in connection part according to claim 10, wherein the latter has a pressure sleeve which is screwable to the inner contact receptacle or the outer contact receptacle, and has a pressure element by means of which a cable guided in the plug-in connection part is sealable or clampable.

12. An inner contact receptacle for a plug screw connection system according to claim 1, wherein the inner contact receptacle comprises a wire-receiving opening extending completely in the longitudinal direction of the inner contact receptacle from a first cover surface to a second cover surface.

13. The inner contact receptacle according to claim 12, wherein a channel is provided between an outer surface of the inner contact receptacle and the wire-receiving opening.

14. Use of a plug screw connection system according to claim 1 for plug connection of a cable with a connection geometry.

15. Use of a plug screw connection system according to claim 1 for flying connection of two cables.
